(19) United States
(12) Patent Application Publication
(10) Pub. No.: US 2015/0140519 A1
(43) Pub. Date: May 21, 2015

(54) METHOD AND SYSTEM FOR COMPUTER AIDED SELECTION OF FASHION ITEMS

(71) Applicant: STYLIT TECHNOLOGIES LTD., Tel Aviv (IL)

(72) Inventors: Michael GUTKIN, Ra'anana (IL); Yaniv NISSIM, Tel Aviv (IL); Shilo Ayalon, Ramat Hasharon (IL)

(73) Assignee: STYLIT TECHNOLOGIES LTD., Tel Aviv (IL)

(21) Appl. No.: 14/081,047

(22) Filed: Nov. 15, 2013

(51) Int. Cl. G09B 19/00; G06F 17/30

(52) U.S. Cl. CPC G09B 19/0023; G06F 17/30342
USPC 434/96

(57) ABSTRACT

Method and system for combined computerized and human experts aided outfit selection are provided herein. The method may include the following steps: presenting questions and receiving answers from users over the at least one user terminal, wherein the answers are indicative of fashion preference of the users; storing user profile data and their respective fashion preferences based on the answers; enabling expert users to generate, over expert terminals, for a giver user profile, an outfit, wherein the generated outfit is selected from a plurality of outfit items stored on a database; monitoring the generating of the outfits by the expert users, to yield monitoring data; storing match data indicating of match between user profiles and generated outfits, based on the monitoring data; and dispatching an outfit to the at least one user, based on fashion preference of the user, a respective user profile, and the match data.

### FIELD OF THE INVENTION

The present invention relates generally to the field of computer aided decision making and, more particularly, to a computerized platform for user customized selection of fashion outfits and items.

### BACKGROUND OF THE INVENTION

Choosing an outfit is an everyday task. Doing it right is a challenge that requires talent, style and experience. Some people use a stylist as a one-off experience, while others use stylists on an ad hoc basis in order to develop a personal style. Still, the use of professional stylists is beyond reach for most people.

Professional stylists usually employ an interactive process while creating an outfit based on a given database of items. The stylist (hereinafter: the expert user) can use a graphical user interface by which he or she can add, omit, and spatially manipulate the selected items over a canvas, to yield a potential outfit that may be then graphically enhanced for perfection.

It would, therefore, be advantageous to be able to provide a computerized platform which utilizes the professional ability and experience of a few human experts and yet cater for a large number of users who will receive suggested outfits that are tailored per their preferences, profiles and needs.

### SUMMARY OF THE INVENTION

According to some embodiments of the present invention, a combined computerized and human experts aided outfit selection platform is provided herein. The method may include the following steps: presenting questions and receiving answers from users over the at least one user terminal, wherein the answers are indicative of fashion preference of the users; storing user profile data and their respective fashion preferences based on the answers; enabling expert users to generate, over expert terminals, for a given user profile, group profile, an outfit, wherein the generated outfit is selected from a plurality of outfit items stored on a database; monitoring the generating of the outfits by the expert users, to yield monitoring data; storing match data indicating of match between user profiles and generated outfits, based on the monitoring data; and dispatching an outfit to the at least one user, based on fashion preference of the user, a respective user profile, and the match data.

These additional, and/or other aspects and/or advantages of the present invention are set forth in the detailed description which follows.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a high level block diagram illustrating a potential architecture of a system according to embodiments of the present invention;

FIG. 2 is a high level flowchart illustrating an aspect of a method according to embodiments of the present invention; and

FIG. 3 is a high level process diagram illustrating an aspect according to embodiments of the present invention.

The drawings together with the following detailed description make the embodiments of the invention apparent to those skilled in the art.

### DETAILED DESCRIPTION OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before the embodiments of the invention are explained in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

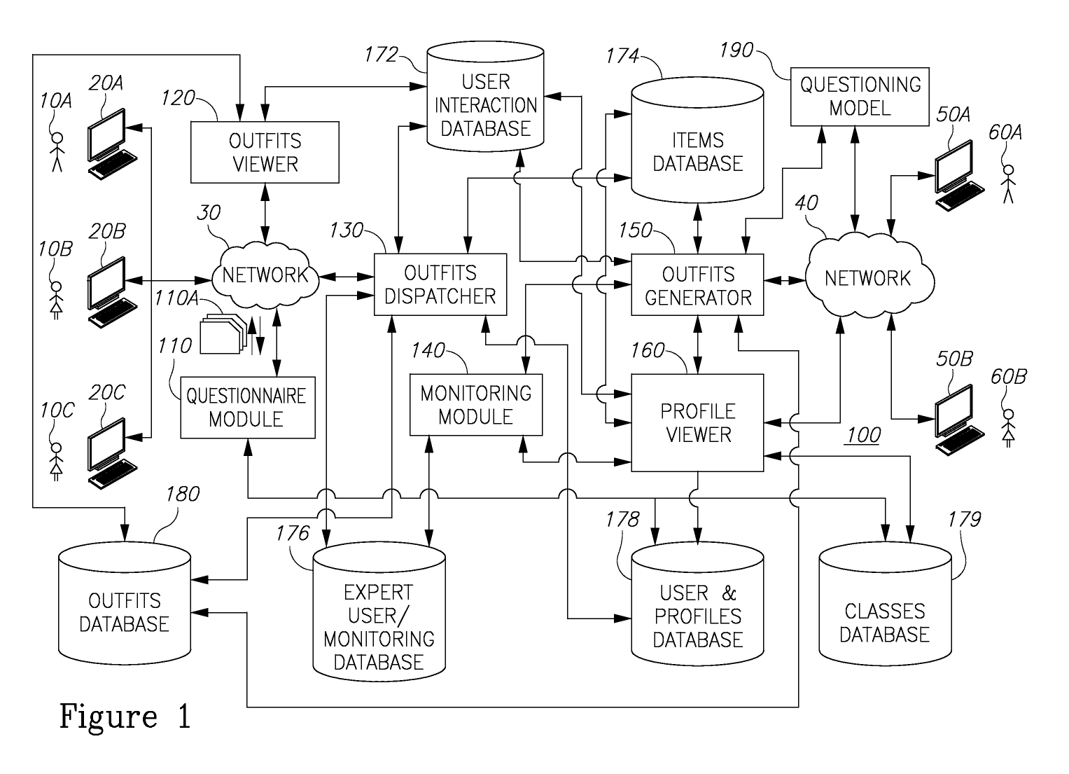

FIG. 1 is a diagram illustrating a system 100 according to embodiments of the present invention. Human users 10A-10C each interacting with a respective user terminal 20A-20C are connected to a computer network 30 implemented by a combination of software and hardware including computer processors. System 100 may include a questionnaire module 110 configured to present questions 110A and receive answers to users 10A-10C over user terminals 20A-20C, wherein the answers are indicative of fashion preference of users 10A-10C.

System 100 may include a user and profile database 178 configured to store user profile data and their respective fashion preferences based on the questionnaire module 110. System 100 may include a classes database 178 configured to store classes profile data and their respective fashion preferences of a class of users based, on the questionnaire module 110. System 100 further includes an items database 174 configured to store a plurality of fashion items for use of stylists 60A and 60B.

System 100 further includes at least one expert user terminal 50A and 50B associated with a respective expert users 60A and 60B and an outfit generator 150 configured to enable the fashion expert users 60A-60B to generate, for a given class profile, an outfit, wherein items of the generated outfit is selected from items database.

Outfit generator 150 may include a combination of a search engine and outfits editor in the form of a graphical user interface (GUI). The search engine allows the expert user to search for appropriate items over the items database 174, given class profile and the outfits editor enables the expert users to create the canvas with the specified outfit.

System 100 may further include a monitoring module 140 configured to monitor the iterative process of creating and generating of the outfits by the expert users. The monitoring may include a recordation of the search, save, select, align, and modify stages of the creation of the outfit over the canvas. System 100 may further include an expert user/monitoring database 176 configured to store data indicating of match between user profiles and generated outfits, based on monitoring module 140.

System 100 may further include an outfit dispatcher 130 configured to dispatch an outfit to a user based on any of the following: fashion preference of the user., possibly based on questionnaire module 110, a respective user profile possibly from user profile database 178, data from the expert users/monitoring database 176, and data taken from a respective user interaction database 172.

According to some embodiments of the present invention, an outfit may include a spatial combination of fashion items over a canvas, including links from where items can be bought, and text that has some reference to the outfit.

According to some embodiments of the present invention, system 100 may further include a user interaction database 172 configured to store data indicative of feedback provided by the users responsive to the dispatched outfits and wherein the outfit dispatcher 130 is further configured to base the dispatching on the feedback. The feedback can be either implicit or explicit, indicating the satisfaction of the users, and relating to ranks and performance of the stylists and their corresponding outfits.

According to some embodiments of the present invention, expert users 60A-60B may be provided with said feedback which may include ranking and performance that entail from user satisfaction of the outfits) and wherein monitoring module 140 may be configured to monitor the user experts while generating a modification to the dispatched outfits (e.g., from outfits database 180), responsive to said feedback. The monitoring module 140 writes into expert users/monitoring database 176. Outfit dispatcher 130 may dispatch outfits generated using outfit generator 150 and stored on outfits' database 180 which is connected to outfit viewer 120 which is in turn used by users 10A-10C. Outfit generator 150 may also use previously generated outfits stored on outfits database 180 possibly with some amendments.

The system may further include a questioning module 190 which may present to the stylists explicit questions as to the reasons for selecting or deselecting a specified item bases on a predefined questioning model. The questioning module 190 will provide more monitoring data required for improving the expert users/monitoring database. Specifically, it will enable to know the reasoning and the motivation of the stylist associated with the selection or the omission of a specified fashion item.

According to some embodiments of the present invention, one or more questions of either questioning model 190 or questionnaire module 110 may include at least one of: implicit and explicit questions or any combination thereof.

According to some embodiments of the present invention, the monitoring by the monitoring module 140 may include recording the searching for items, selection of items, combining the items together and updating the selection and the combining of the items, to yield monitoring data.

According to some embodiments of the present invention, outfit dispatcher 130 may be further configured to use the monitoring data in dispatching the outfits to the user.

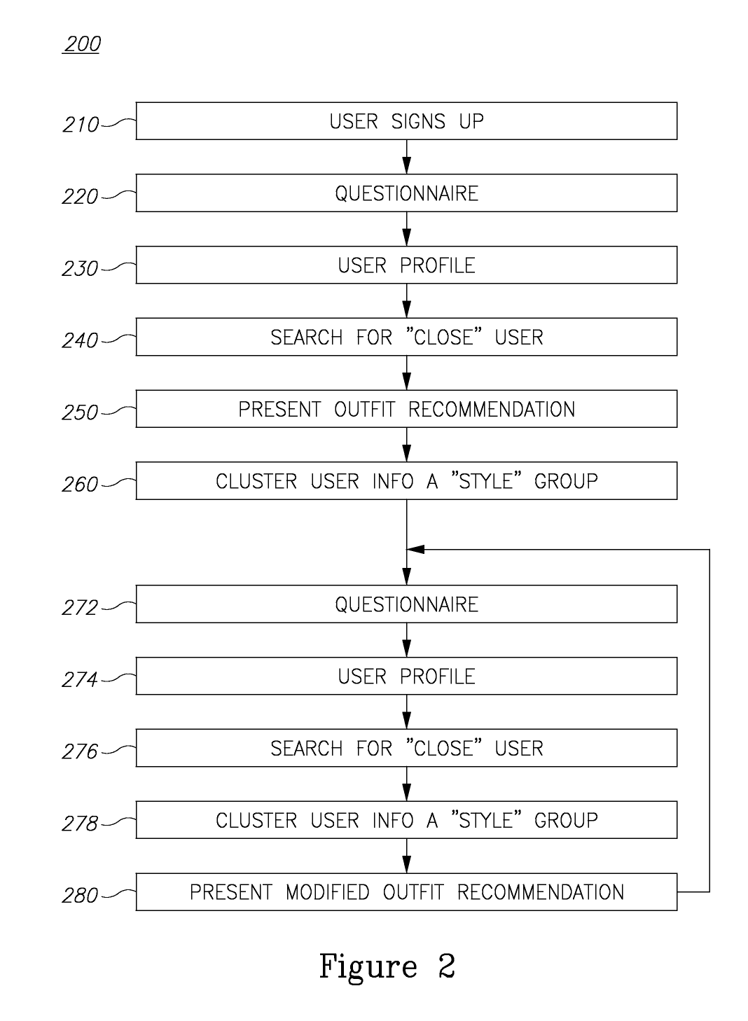

FIG. 2 is a high level flowchart illustrating an aspect of a method according to embodiments of the present invention. Method 200 shows an exemplary flow according to which, after a user signs in 210, he or she is presented with a questionnaire 220 which is used to create an associate with a user profile 230. Then, a search for a “close” user or class is made of the databases 240 and a recommended outfit is presented 250. Then, the user is clustered into a style group that is representative of the user 260. Then, in an iterative loop, the following stages may be repeated, entirely or partially, as the case may require: presenting an up dated questionnaire 272 which is used to create an associate with a user profile 274. Then, a search for a “close” user or class is made of the databases 276. Then, the user is clustered into a style group that is representative of the user 278 and a modified recommended outfit is presented 280.

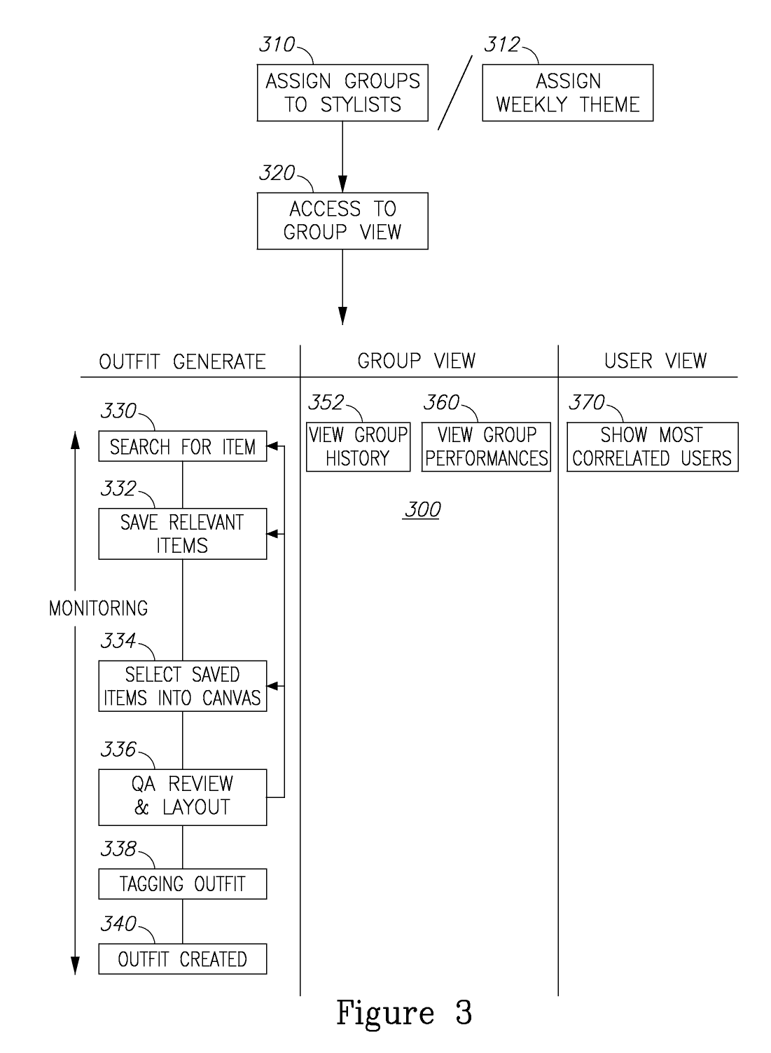

FIG. 3 is a high level process diagram illustrating an aspect according to embodiments of the present invention. In process 300, the system assigns groups of people (users 10A-10C) to the stylists (expert users 60A-60B) 310 and at the same time, a theme for the styling is assigned for a specified period of time such as, in a non-limiting example, a week. Then, the system provides access to some of the groups (a subset of all groups of users) to the stylists 320. Then, in a sub process as detailed above, an outfit is being generated by letting the stylists search for items 330 possibly over the aforementioned search engine. Then, some of the items selected by the stylists are saved 332 and out of the saved items, some of them are being selected into the canvas 334. Once the outfit is generated, it is being tightly reviewed by quality assurance personnel such as supervisory expert stylists, and further the layout is being reviewed 336. In the process of generating the outfit, each generated outfit may be tagged either manually of automatically 338. The tagging provides metadata associated with the generated outfits and may serve for search engine applications. It is understood that all of the aforementioned steps may be monitored either partially or entirely. Finally, the outfit is being created and presented to the user.

At the group view, it is possible to view the history of each group and monitor the behavior of the groups over several weeks of time 352. At the time, the group view enables to view groups to view the group correlated users 360. At the user view, the most correlated users may be presented 370. The most correlated users may be used in order to recommend a user with a specified profile that is correlated with a specified user.

Advantageously, after tagging the items and the outfits, the search engine of the outfits generator 150 may be used to provide a better search capability over items database 174 and outfits database 180 for the fashion industry and this search capability may be beneficial for end users other than the expert users as described hereinabove.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising:
at least one user terminal associated with a user;
a questionnaire module configured to present one or more questions to users and receive answers over the at least one user terminal, wherein the answers are indicative of fashion preference of the users;
a user and profile database configured to store user profile data and their respective fashion preferences based on the questionnaire module;
a classes profile database configured to store classes profile and their respective fashion preferences based on the questionnaire module;
an items database configured to store a plurality of fashion items;
at least one expert user terminal associated with a respective expert user;
an outfit generator configured to enable the fashion expert users to generate, for a given class profile or a user profile, an outfit, wherein the generated outfit is selected from the items database;
a monitoring module configured to monitor the generating of the outfits by the expert users, to yield monitoring data;
an outfits database configured to store the generated outfits;
an outfit dispatcher configured to dispatch an outfit from the outfits database to a user, based on fashion preference of the user, a respective user profile, and the monitoring data.

2. The system according to claim 1, further comprising a user interaction module configured to derive feedback from the users responsive to the outfit dispatching, and wherein the outfits dispatcher is further configured to update the dispatching of the outfits, based on the feedback

3. The system according to claim 1, wherein an outfit comprises a spatial combination of fashion items over a canvas.

4. The system according to claim 2, wherein the expert users are provided with said feedback and wherein the monitoring module is configured to monitor the user experts while generating a modification to the dispatched outfits, responsive to said feedback.

5. The system according to claim 1, wherein said questions of said questionnaire module comprise at least one of: implicit and explicit questions.

6. The system according to claim 1, wherein the monitoring by the monitoring module comprises at least one of: recording the selection of items, combining the items together and updating the selection and the combining of the items, to yield monitoring data.

7. The system according to claim 6, wherein the outfit dispatcher is further configured to use the monitoring data in dispatching the outfits to the user.

8. A method comprising:
presenting questions and receiving answers from users over the at least one user terminal, wherein the answers are indicative of fashion preference of the users;
storing user profile data and their respective fashion preferences based on the answers;
enabling expert users to generate, over expert terminals, for a given user or class profile, an outfit, wherein the generated outfit is selected from a plurality of outfit items stored on a database;
monitoring the generating of the outfits by the expert users, to yield monitoring data and storing it;
storing match data indicating of match between user profiles and generated outfits, based on the monitoring data; and
dispatching an outfit to the at least one user, based on fashion preference of the user, a respective user profile, and the match data.

9. The method according to claim 8, wherein an outfit comprises a spatial combination of fashion items over a canvas.

10. The method according to claim 8, further comprising storing feedback data indicative of feedback provided by the users responsive to the dispatched outfits and wherein the dispatching is further carried out based on the feedback data.

11. The method according to claim 10, wherein the expert users are provided with said feedback and wherein the method further comprises monitoring the user experts while generating a modification to the dispatched outfits, responsive to said feedback.

12. The method according to claim 8, wherein said questions of said questionnaire module comprise at least one of: implicit and explicit questions.

13. The method according to claim 8, wherein the monitoring by the monitoring module comprises recording the selection of items, combining the items together and updating the selection and the combining of the items, to yield monitoring data.

14. The method according to claim 13, wherein the dispatching utilizes the monitoring data.

15. A tangible computer program product comprising:
a non-transitory computer readable storage medium having computer readable program embodied therewith, the computer readable program comprising:
computer readable program configured to present questions and receiving answers from users over the at least one user terminal, wherein the answers are indicative of fashion preference of the users;
computer readable program configured to store user profile data and their respective fashion preferences based on the answers;
computer readable program configured to enable expert users to generate, over expert terminals, for a giver user profile, an outfit, wherein the generated outfit is selected from a plurality of outfit items stored on a database;
computer readable program configured to monitor the generating of the outfits by the expert users, to yield monitoring data and store it;
computer readable program configured to store match data indicating of match between user profiles and generated outfits, based on the monitoring data; and
computer readable program configured to dispatch an outfit to the at least one user, based on fashion preference of the user, a respective user profile, and the match data.

16. The computer program product according to claim 15, wherein an outfit comprises a spatial combination of fashion items over a canvas.

17. The computer program product according to claim 15, further comprising computer readable program configured to store data indicative of feedback provided by the users responsive to the dispatched outfits and computer readable program configured to base the dispatching on said feedback.

18. The computer program product according to claim 17, wherein the expert users are provided with said feedback and wherein the computer program product further comprising computer readable program configured to monitor the user experts while generating a modification to the dispatched outfits, responsive to said feedback.

19. The computer program product according to claim 15, wherein said questions of said questionnaire module comprise at least one of: implicit and explicit questions.

20. The computer program product according to claim 15, wherein the monitoring by comprises recording the selection of items, combining the items together and updating the selection and the combining of the items, to yield monitoring data.
